(19) United States
(12) Patent Application Publication
(10) Pub. No.: US 2009/0172821 A1
(43) Pub. Date: Jul. 2, 2009

(54) System and method for securing computer stations and/or communication networks

(76) Inventors: Faycal Daira, Paris (FR); Alexandre Buge, Paris (FR); Romain Dequidt, Paris (FR)

Correspondence Address: BLANK ROME LLP, WATERGATE, 600 NEW HAMPSHIRE AVENUE, N.W., WASHINGTON, DC, 20037, US

(21) Appl. No.: 11/631,120

(22) PCT Filed: Jun. 30, 2005
(86) PCT No.: PCT/FR05/01667

§ 371 Date: Oct. 3, 2008

(30) Foreign Application Priority Data
Jun. 30, 2004 (FR) 0407254

(51) Int. Cl. G06F 21/20; G06F 15/173; H04L 9/32; G06F 17/30; G06F 11/30; G06F 3/048; G06F 15/18

(52) U.S. Cl. 726/27; 709/223; 726/4; 707/5; 726/22; 715/781; 706/12; 726/1

(57) ABSTRACT

The invention relates to a method for securing computer equipment (client stations) connected by a computer network or communication network and forming at least on information system, said system comprising at least on computer server, characterized in that it comprises two stages wherein digital data relating to the security of the network and/or system(s) is correlated. The invention also relates to a system for securing wireless digital communication networks.

The present invention relates to the field of information and communication systems.

The present invention relates, more specifically, to the field of security in information and communication systems.

Numerous systems and methods which have the aim of improving the security of networks or computer systems are known in the state of the art.

Patent application PCT WO 03/092242 (IBM) provides a method and a system for dynamic reconfiguration of encryption upon detection of intrusion. Since an eavesdropper listening adjacent to a wireless LAN is likely to be mobile and operating on a short time cycle, he himself is likely to be wirelessly transmitting his test message. Consequently, the invention provides the combination of apparatus for eavesdropping within an area layer adjacent to and surrounding the LAN area periphery for potential wireless transmissions of an intruder having a lower frequency within a level below the LAN frequency and addressed to the network location of any one of the computer terminals in the LAN, and an implementation responsive to said eavesdropping means for changing the encryption code of said encrypted wireless transmission upon the eavesdropping detection of a wireless transmission of said lower frequency addressed to a network location of one of the terminals in said LAN. Several factors contribute to the success of the process of the invention. It is likely that the intruder must send his message at a lower frequency than the 2.4 GHz frequency of the LAN area transmissions because the intruder will probably have to reach a base station tower over a longer distance or range than the adjacent target wireless LAN facility. This ensures that the eavesdropping of the present invention will be at a lower frequency and, thus, not interfered with by the transmissions within the LAN.

The prior art also knows, from patent application PCT WO 01/39379 (TGB Internet), a method for automatic intrusion detection and deflection in a network. The invention of this PCT patent application relates to a method and a system making it possible to secure a network. Said method consists, at least, of identifying an unauthorised user who is attempting to gain access to a node on the network, and preferably of then actively blocking that unauthorised user from further activities. Detection is facilitated by the unauthorised user providing ‘earmark’, or specially crafted false data, which the unauthorised user gathers during the information collection stage performed before an attack. The earmark is designed such that any attempt by the unauthorised user to use such false data results in the immediate identification of the unauthorised user as hostile, and indicates that an intrusion of the network is being attempted. Preferably, further access to the network is then blocked by diverting traffic from the unauthorised user to a secure zone, where the activities of the unauthorised user can be contained without damage to the network.

Also known in the state of the art is U.S. Pat. No. 6,578,147 (CISCO), which relates to parallel intrusion detection sensors with load balancing for high-speed networks. This U.S. patent describes a method and a system for detecting unauthorised signatures to or from a local network. Multiple sensors are connected to an interconnection device, which can be a router or a switch. The sensors operate in parallel and each receives a portion of traffic through the interconnection device, at a session-based level or at a lower (packet-based) level. Depending on the type of interconnection device (router or switch) the load balancing mechanism that distributes the packets can be internal or external to the interconnection device. Also depending on the level of packet distribution (session-based or packet-based), the sensors share a network analyzer (if session-based) or both a network analyzer and a session analyzer (if packet-based).

Patent application PCT WO 03/21851 (Newbury Networks) also provides a method and a system for position detection and location tracking in a wireless network. The invention of this PCT patent application relates to a system and a method for performing real-time position detection and motion tracking of mobile communications devices moving about in a defined space comprised of a plurality of locales. A plurality of access points are disposed about the space to provide an interface between mobile devices and a network having functionality and data available or accessible therefrom. Knowledge of adjacency of locales may be used to better determine the location of the mobile device as it transitions between locales and feedback may be provided to monitor the status and configuration of the access points.

The prior art also knows, from patent application PCT WO 03/023555 (Wavelink), an internet-deployed wireless system. The invention described in this PCT patent application relates to an internet-deployed wireless system comprising an application server program configured to be downloaded to and to execute on one or more remote wireless application server computers. The application server program is also configured to cause the one or more remote application server computers to download and to install one or more wireless application software components. The application server program is further configured to transmit to one or more portable devices one or more client applications and to cause the one or more portable devices to install the one or more client applications. The client applications are configured to communicate with a local wireless application server computer over a wireless network.

The prior art also knows, from patent application PCT WO 04/04235 (Wavelink), a system and a method for detecting unauthorised wireless access points. According to the invention described and claimed in this international patent application, unauthorised wireless access points are detected by configuring authorised access points and mobile units to listen to all wireless traffic in its cell and report all detected wireless devices to a monitor. The monitor checks the reported devices against a list of authorised network devices. If the reported wireless device is not an authorised device, the monitor determines if the reported device is connected to the network. If the reported device is connected to the network and is not an authorised device, the monitor alerts the network operator or network administrator of a rogue device connected to the network and attempts to locate and isolate the rogue device.

Also known in the state of the art, from patent application PCT WO 04/15930 (Wavelink), is a method and a system for the management of mobile unit configuration in wireless local area networks. The invention which is the subject of this international patent application relates to a system for enforcing configuration requirements for hardware and software on mobile units operating on Wireless Local Area Networks (WLAN). The system allows the configuration policy to change dynamically with the access point or sub-network association. Whenever a mobile unit connects to a new sub-network or access point, the system invokes and then verifies the proper configuration profile for that sub-network or access point. Thus the system ensures the configuration of the mobile unit meets the requirements for the sub-network being used.

Also known in the state of the art, from European patent application EP 1 311 921 (Internet Security Systems), is a method and an apparatus for network assessment and authentication. The invention described and claimed in this European patent application relates to providing a user with assurance that a networked computer is secure, typically before completion of the log-in operation. This can be accomplished by extending the local log-in process to perform a host assessment of the workstation prior to requesting the user's credentials. If the assessment finds a vulnerability, the log-in process can inform the user that the machine is or may be compromised, or repair the vulnerability, prior to completion of the log in operation.

By performing vulnerability assessment at the level of the workstation, a network server is able to determine whether the workstation is a “trusted” platform from which to accept authentication requests. If the vulnerability assessment shows that the workstation is compromised, or if the possibility of remote compromise is high, the network server can elect to fail the authentication on the grounds that the workstation cannot be trusted. Optionally, a vulnerability assessment tool may be able to repair the vulnerability of the workstation, and then allow the authentication to proceed.

Also known in the prior art, from U.S. patent application US 2002/0184532 (Internet Security Systems), is a method and a system for implementing security devices in a distributed computer network. A security interface provides a universal platform for coupling security modules to the network. The various security modules are linked to and provide identifying information to the security interface. The security interface also receives subscription requests used to coordinate which security modules will communicate. When a security event occurs, a message can be generated by the relevant security module. The security interface shares the message with these security modules. The sharing of security information enables better performance by the entire network security system.

Also known in the prior art, from patent application WO 03/58451 (Internet Security Systems), is a system and a method of managed security control of the processes on a computer system. The invention, which is the subject of this international patent application, relates to a system and a method for managing and controlling the execution of software programs with a computing device to protect the computing device from malicious activities. According to the invention, a protector system implements a two-step process to ensure that software programs do not perform malicious activities which may damage the computing device or other computing resources to which the device is coupled. In the first phase, the protector system determines whether a software program has been previously approved and validates that the software program has not been altered. If the software program is validated during the first phase, this will minimise or eliminate security monitoring operations while the software program is executing during the second phase. If the software program cannot be validated, the protector system enters the second phase and detects and observes executing activities at the kernel level of the operating system so the suspicious actions can be anticipated and addressed before they are able to do harm to the computing device.

The prior art also knows, from patent application WO 02/103498 (Okena), a Stateful Reference Monitor. The invention of this PCT patent application relates to a Stateful Reference Monitor which can be loaded into an existing commercial operating system, and then can regulate access to many different types of resources. The reference monitor maintains an updateable storage area whose contents can be used to affect access decisions, and access decisions can be based on arbitrary properties of the request.

Finally, patent application PCT WO 02/103960 (Okena) is also known in the state of the art, which relates to stateful distributed event processing and adaptive security. The invention of this international patent application provides a method and an apparatus for maintaining the security of a networked computer system including first and second nodes and an event processing server, the method being carried out as follows: the first and second nodes detect changes in state, the event processing server receives notification of the changes in state from the first and second nodes, the event processing server correlates changes in state detected in the first and second nodes, and the event processing server executes a maintenance decision which affects the first and second nodes. The detecting, transmitting, correlating, and executing occur without human intervention.

The present invention intends to solve the disadvantages of the prior art by providing a truly innovating and original security solution based on the following concept: the pre-processes are performed in the client equipment while, in the solutions known in the state of the art, all the processes are carried out at the server level.

The present invention aims to achieve, by means of a very efficient solution, optimum security in networks as well as in client workstations, while preserving reasonable costs and very high performance levels.

For this purpose, the present invention relates, according to its broadest meaning, to a method of securing computer equipment (called client workstations) connected to each other by means of a computer network or a communication network and forming at least one information system, said system comprising at least one computer server, characterised in that it comprises two steps of correlating digital data relating to the security of the network and of the system or systems, the first step being implemented in the client workstation(s), combining system data (of the operating system and local applications) on the one hand, and data obtained from the network (inputs/outputs of the client workstation) on the other hand by scanning the entire layers, known as OSI model (Open System Interconnection) from the so-called transport layer to the so-called application layer; the second step being executed in the server by combining so-called “history” data obtained from digital databases, other “history” data stored in the memory, for example but not necessarily statistical data, signatures or rules such as policy rules, and correlation data obtained from said first step.

The method preferably also comprises a step of correlation with user events at the client workstation level, such events being considered as executables.

Said method advantageously implements XML (extended Markup Language) technology.

The present invention also relates to a method of managing computer attacks implementing the security method characterised in that it comprises a step that consists of sending at least one blocking command.

According to a first variant, the blocking command is sent to a router.

According to a second variant, the blocking command is sent to a terminal or an access point.

According to another variant, the blocking command is sent to a firewall.

According to further particularly advantageous variants, the blocking command is sent to one or more of said client workstations or to one or more computer applications.

Advantageously, the (at least one) blocking command is limited in the time domain, by means of a network management console or else in a predetermined fashion.

According to a specific embodiment of the invention, the (at least one) blocking command is sent when an event that fulfils a specific criterion occurs, said specific criterion being, for example but not necessarily, a port, an application, services, frames or packets.

At least part of said system data from said first step is preferably defined following a step of learning about the behaviour of the system.

Said method advantageously comprises, in addition, a step of the administrator qualifying the decisions made by the system, and at least part of said “history” data from said second step is defined following a step of learning about said administrator qualifications.

The present invention also relates to a system for securing digital communication networks, comprising:
at least one computer server;
at least one digital database;
at least one network management console implemented on a client workstation;
at least one user workstation on which a specific application is installed, in particular one which has “probe” type functions;
said (at least one) server being connected to said (at least one) digital database, and to said (at least one) network management console by a first cabled communication network (fixed) comprising a private part and a DMZ-type semi-public part (. . . );
said first network being connected to a wireless network (the one that the invention intends to secure) or to a plurality of networks by means of equipment such as a “network gateway”;
said user workstation being connected to said network;
   characterised in that
said specific application emits, periodically and/or according to the performance of a specific event, digital data relating to the client workstation comprising indicators relating to at least one of the following parameters:
   i. attacks/security;
   ii. network reception quality;
   iii. malfunctions of the specific application;
the server comprises means for correlating, on the one hand, said digital data relating to the client workstation and, on the other hand, the data obtained from said database and/or data relating to one or more other client workstation(s), these means supplying correlation indices as their output; means for identifying and categorising possible attacks on the network; means for assessing and grading the relevance of possible risks relating to the data received based on a plurality of criteria: history (with adjustable length), administrator comments, etc.

Said network is preferably a wireless network.

According to a first variant, said network is a Personal Area Network (PAN) such as, for example but not necessarily, Bluetooth.

According to a second variant, said wireless network is a Wireless Local Area Network (WLAN) such as, for example but not necessarily, an IEEE 802.11 network (also known by the name Wi-Fi).

According to a third variant, said wireless network is a Wireless Metropolitan Area Network (W-MAN) such as, for example but not necessarily, a WiMax network.

According to a fourth variant, said wireless network is a digital mobile telecommunications network such as, for example but not necessarily, a GSM, CDMA, W-CDMA, CDMA-2000, UMTS or 4G network.

Said digital database is advantageously a relational DBMS (DataBase Management System).

Said network management console is preferably capable of managing different types of equipment.

The invention will be understood better with the help of the description, provided below for purely explanatory purposes, of an embodiment of the invention, made in reference to the appended figures, wherein:

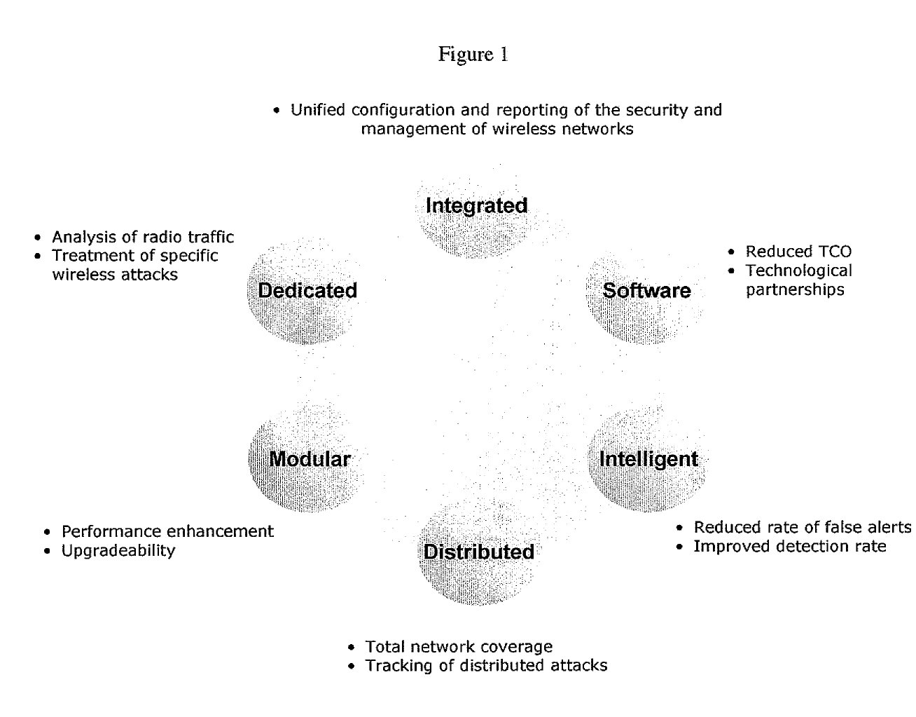

FIG. 1 depicts certain functionalities of the method and system according to the invention;

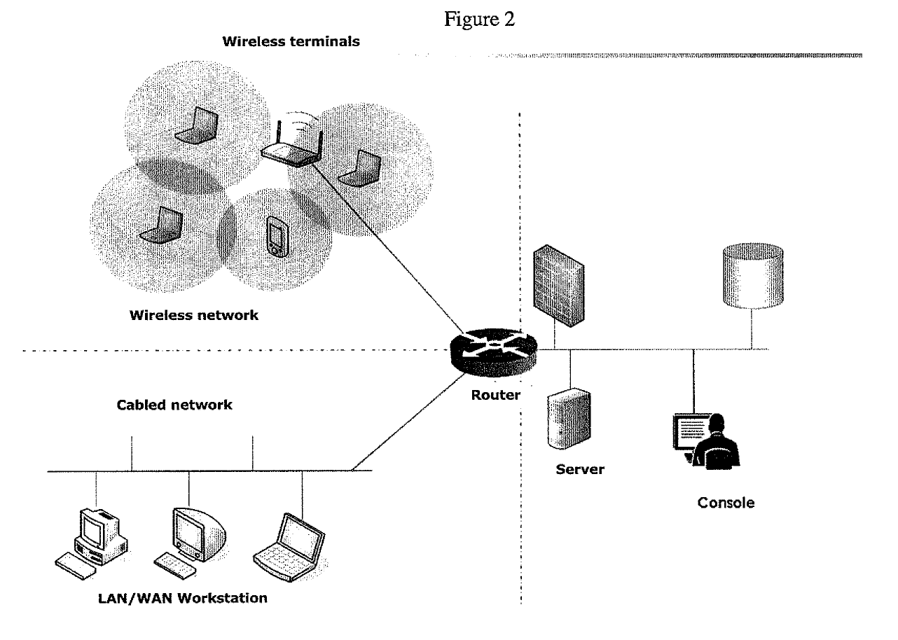

FIG. 2 depicts the physical architecture of the system according to the invention;

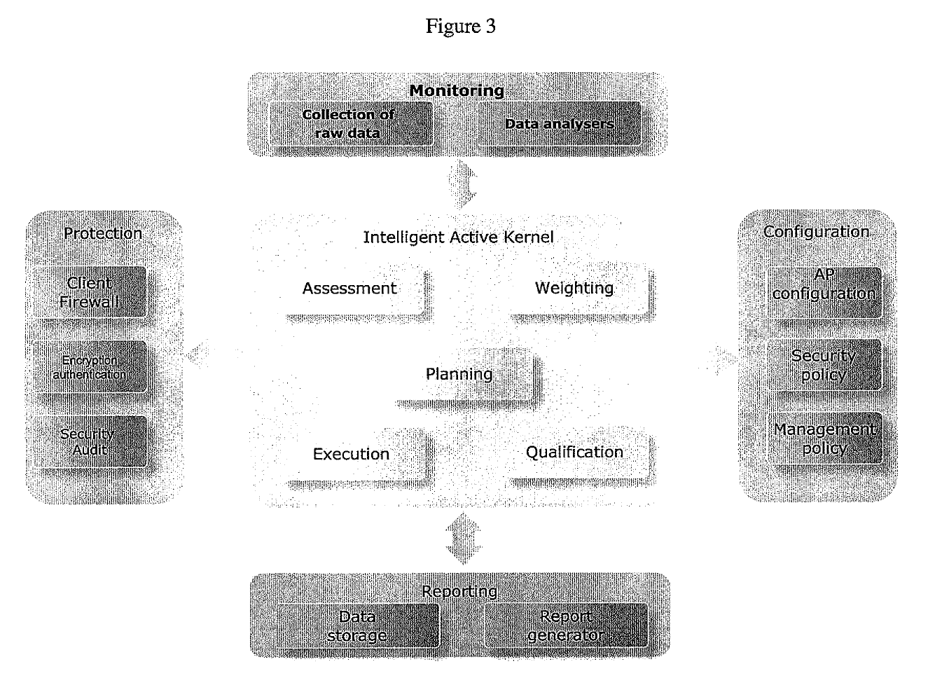

FIG. 3 depicts the logical architecture of the system according to the invention;

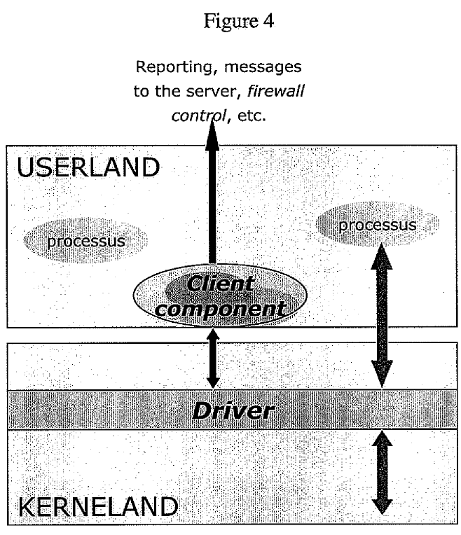

FIG. 4 shows the structure of the intelligent agent according to the present invention;

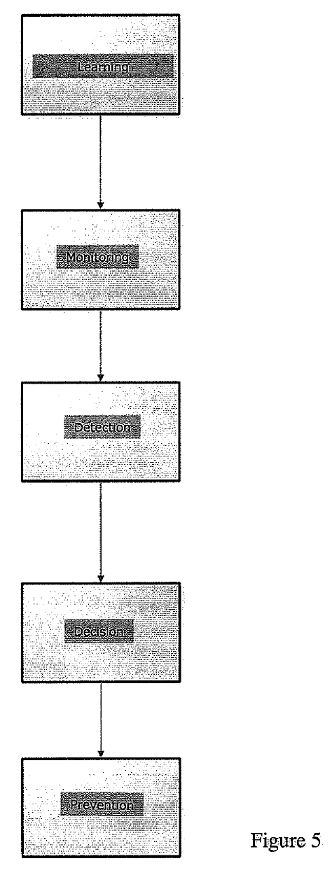

FIG. 5 presents a flowchart of the operation of the present invention;

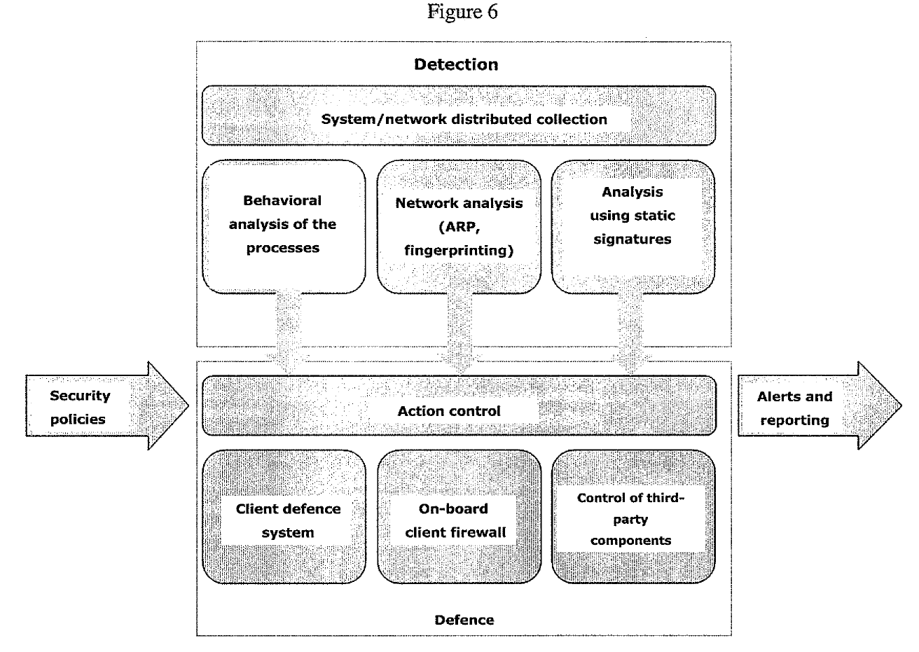

FIG. 6 depicts the operating principle of the present invention;

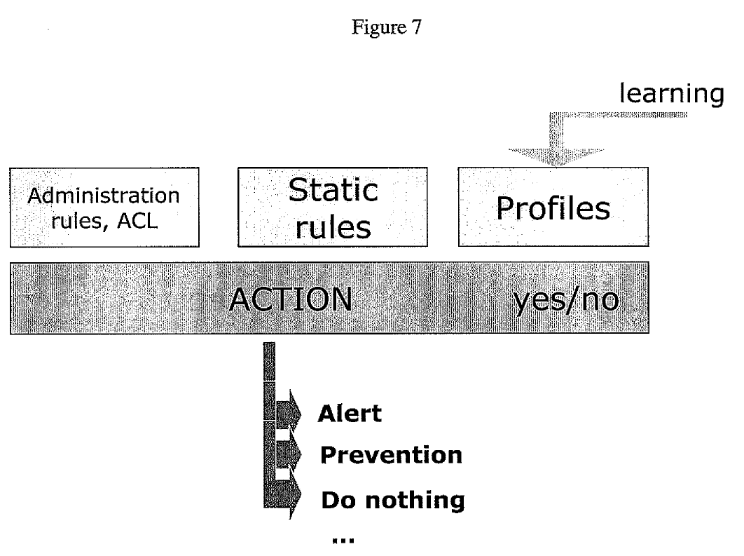

FIG. 7 depicts the system monitoring configuration implemented according to the present invention;

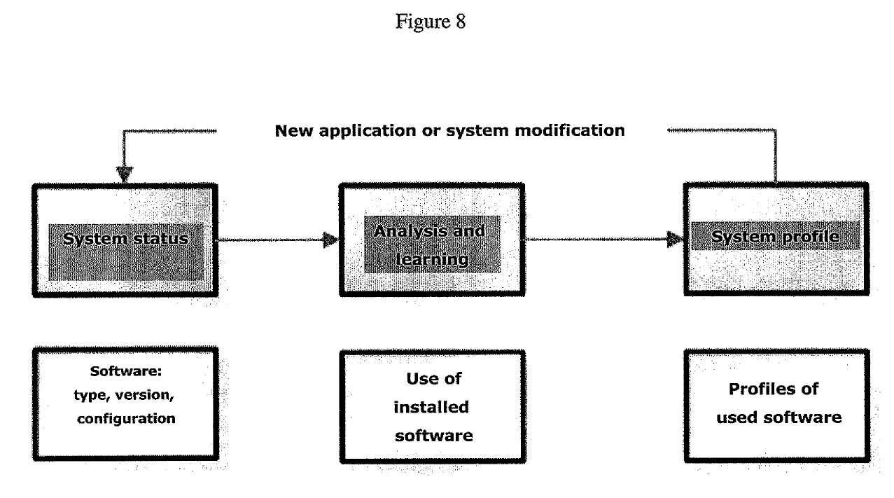

FIG. 8 depicts the overall operation for adapting to a system modification;

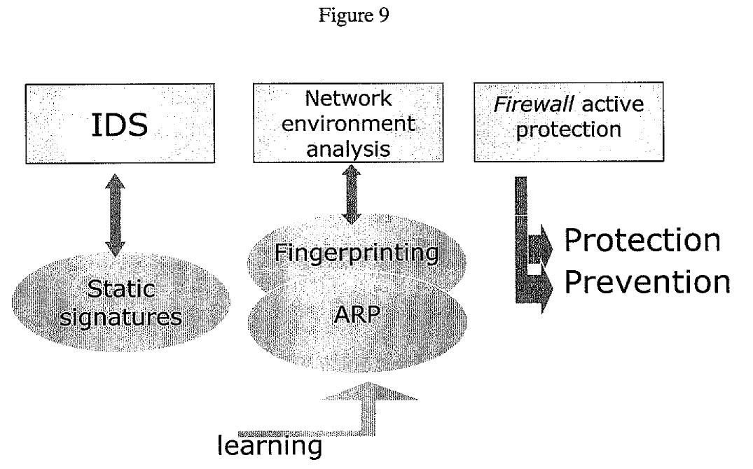

FIG. 9 depicts the network monitoring configuration implemented according to the present invention;

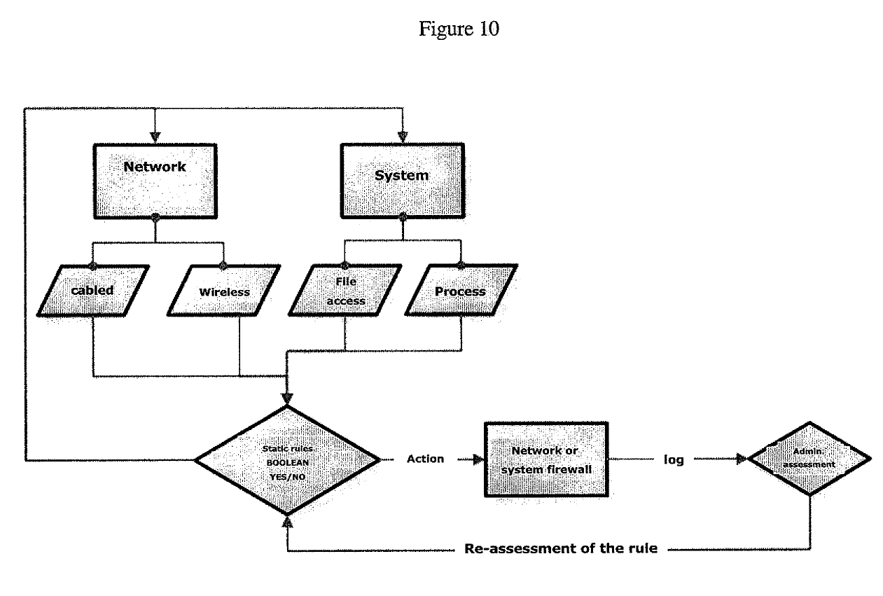

FIG. 10 depicts static learning;

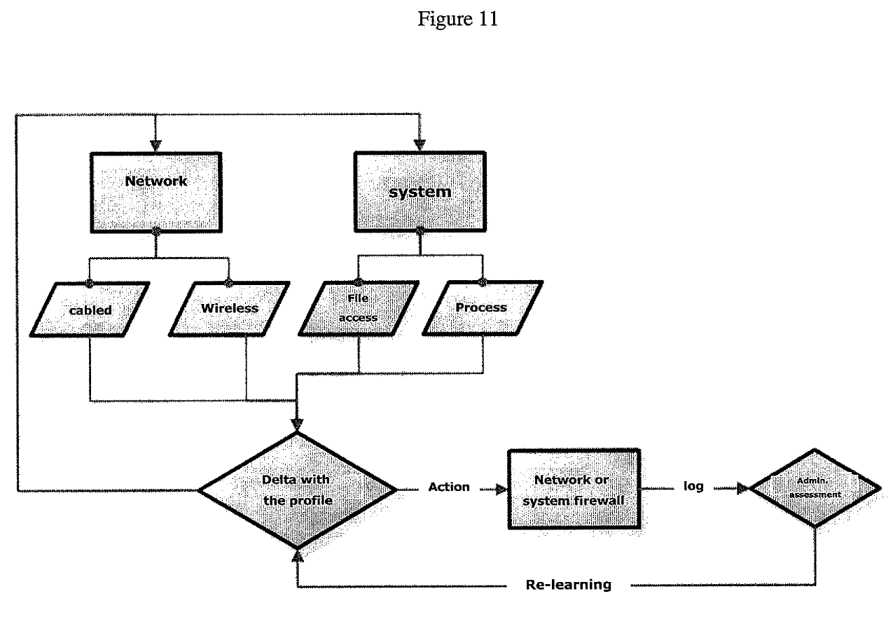

FIG. 11 depicts dynamic learning; and

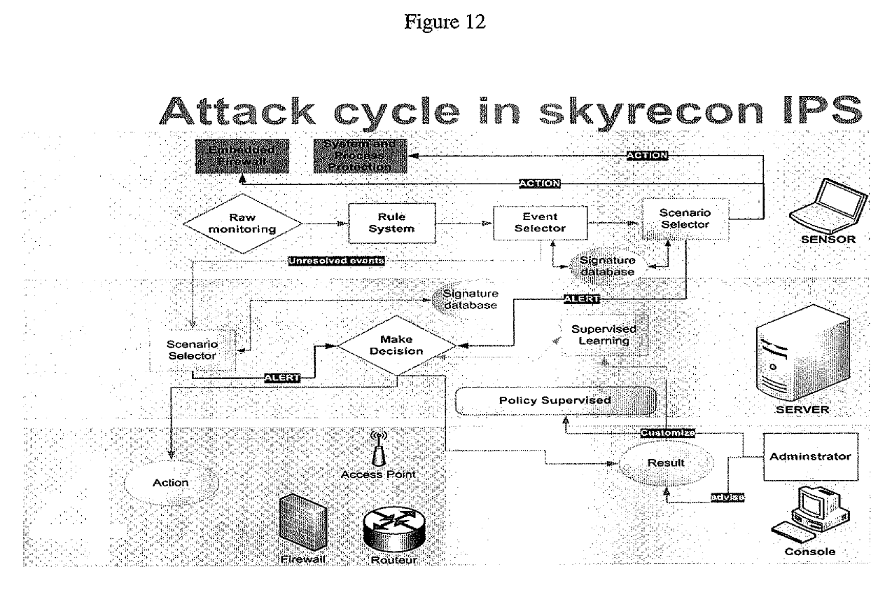

FIG. 12 depicts how an attack cycle is generated by the system according to the present invention.

The present invention provides a solution for the multiple particularities and advantages.

As shown in FIG. 1, network securitisation and management, preferably of wireless networks, can be integrated in a single solution.

The implementation of the invention in software form thus considerably reduces the TCO (Total Cost of Ownership) for purchasers.

The solution according to the invention has a learning system that makes it intelligent, which is to say independent and capable of making decisions. Thus, attacks are detected and stored in the memory by means of an automatic and/or guided learning process. This results in a reduced number of false alerts as well as increased attack detection rates.

A low-level analysis of network traffic (for example, at the wireless radio protocol level) and a treatment of specific attacks make the solution dedicated to wireless technology.

Although specific, this solution remains distributed in that it ensures monitoring of every point of the network, as well as of client workstations, servers and wireless network access points.

The previously mentioned software solution provides performance-enhancing modularity, enables considerable upgradeability of the solution and allows the integration of blocks into existing infrastructure blocks. For this purpose, the architecture used can be CORBA (Common Object Request Broker Architecture). However, simplified architectures enabling relatively higher performance levels can be implemented.

The present invention thus makes it possible to provide active defence and permanent management of the network by:
24×7 intrusion prevention and detection,
permanent monitoring and management of performance, failures, network and equipment configuration,
automatic distribution of the monitoring processes at every point of the network (agents and probes).

For this purpose, the invention implements tracking capacity that is independent from the attack variants, analysis and alert systems capable of filtering irrelevant information, changing adaptation of security policies by means of learning processes or otherwise, predictive analysis of malicious behaviour and an adaptation of the load availability, both on the network and on each client workstation.

In reference to FIG. 2, the system implementing the method according to the present invention comprises a server with which a history database and a network management console are associated by means of a network, this console having administration and supervision tools. According to one embodiment of the invention, this part of the network is a cabled network. The history database is a database for storing events, actions, alerts, etc. that take place.

The system also comprises one or more client workstations (client probes) connected to one or more networks, which can be equally wireless or cables. These networks are interconnected to the cabled administration network by means of routers. All types of wireless networks can be implemented, and these wireless networks can be of identical or different natures. Current technology provides a large number of wireless network types: Bluetooth, Wi-Fi (IEEE 802.11), WiMax, SM, CDMA, UMTS, etc. In the same way, the present invention is not limited to a single type of network.

In one embodiment of the invention, a code constituting a “hard kernel” is installed on each of the machines, providing at least some of the functions of the present invention. The “hard kernel” is the intelligent active kernel in the architecture depicted in FIG. 3. In one embodiment of the invention depicted in FIG. 4, this kernel is a low-level driver (in the kernel part of the machine: kerneland) with which a process executed in the “user” part (userland) of the client machine's system is associated.

The intelligent active kernel, present on the server and on each of the client workstations, actively ensures the security of the system and the enhancement of its performance. For this reason, the kernel interacts with four modules: a configuration module, a protection module (of the network and of the system), a monitoring module (of the network and of the system) and a final module for reporting or recovering information.

In reference to FIG. 5, this kernel follows a cycle during which it monitors the system and the network, detects any anomalies or external attacks, makes a decision and reacts, for example by preventing future attacks. A learning phase allows it to improve its knowledge.

FIG. 6 depicts the general principle of the present invention. A first detection phase implements the analysis of the collected system or network information. Several types of analysis are possible: the behavioural analysis of processes (system) defines a standard profile and any departure from this profile results in the detection of an anomaly, network analysis by several methods (ARP, fingerprinting) and analysis by static signatures present on the server. The correlation of all this information makes it possible, according to the security policies defined by the administrator, to request an action. These security policies can be, for example, independent security ensuring low network security, high system security and static rules specifying that Outlook cannot open .exe files (static system rule) and that the firewall blocks peer-to-peer traffic (static network rule). The action can relate to defending the client system (not opening the file), activating the client firewall (modification of blocked ports) or controlling third-party applications (modification of other machines for preventive purposes). One group of data is sent back to the administrator and stored in the “history” database.

In reference to FIG. 7, the kernel provides monitoring of the client workstation system. For this purpose it relies on ACL (Access Control List) rules, static rules and profiles (behavioural rules capable of being dynamically modified by the system) based on which its makes decisions regarding system actions (alert, reaction, prevention, do nothing, etc.) An example of a profile can be: in the case of a user who never installs programs, the system creates a profile in which access to the registry database is blocked.

According to one embodiment, the present invention implements a learning system. This system has the aim of preventing and protecting against all forms of application attacks. The protection consists of a simple access control list (ACL) system defined by the administrator which adjusts, blocks and protects various resources. The files are protected against opening, with occasional restrictions on read-only access. All the files are affected. For example, the administrator blocks the opening of .exe files in Outlook in order to prevent the installation of a virus. The sockets, in turn, are blocked when a “BIND”, “CONNECT”, “ACCEPT” or “LISTEN” access is requested. Process protection consists, for example, of preventing any attempt to tie in with a third-party process by means of a trusted process, such as explorer.exe.

Initially, critical system information (file access, network access, DLL loading, etc.) is collected in order to create application profiles that determine the “proper” operation of the application. These profiles are stored locally. The learning system then performs a behavioural analysis of the process. This consists of learning the use and operation of a process. Following this learning process, a profile is created for each application. This profile makes it possible to define the normal operation of the application. If the application departs from this operating profile, a more or less serious anomaly is suspected. If the anomaly is serious, then the action of the program is blocked, since it is suspected that this application is probably corrupted. This analysis is entirely automatic and completely independent, and does not require any supervision.

In reference to FIG. 8, system modifications require an analysis of the new status of the system and the learning of this new information in order to create a new profile.

In a similar manner, in reference to FIG. 9, the kernel monitors the network component of the client workstation. For this reason, an intrusion detection system (IDS) is set up, based on static signatures and an environmental analysis of the network by means of fingerprinting analysis, ARP cache and wireless aspects (for example, the environment of access point AP lists, the MAC addresses of the APs). The means for action then concentrate on the firewall which ensures protection and/or prevention according to the decisions made.

The control of the “network” environment makes it possible to recognise the surrounding servers and/or clients from their signatures (or fingerprinting). This makes it possible, in particular, to detect the operating system type and possibly the operating system version by examining the packets exchanged using network protocols (TCP, IMCP, ARP, etc.). This control can implement active fingerprinting, which is to say during the connection of a new entity to the network and/or passive fingerprinting, for example when a piece of network equipment establishes a connection (a request) with another piece of equipment.

It is possible to distinguish between three types of rules that condition the way the system reacts to attacks.

First of all, are authorised action rules. For example, Word, the word-processing application by US corporation Microsoft (registered trademark), only opens computer files that have a .doc extension, and this is the only application that opens .doc files. This innovating function is applied to network connections, to lists of applications for a given extension and to lists of extensions that an application can open.

Next, the rules are defined according to predefined actions such as, for example, the injection of .dll files, re-booting, etc.

Finally, the learning rules show the “intelligent” nature of the system. Certain technical processes such as learning, behavioural analysis and profiling of sub-processes are also implemented with the essential aim of optimising efficiency in terms of resources required or the ratio of performance to resources. This makes it possible to ensure protection against new attacks, which is to say unanticipated attacks. In reference to FIGS. 10 and 11, following the detection of an attack and an action in response to such attack, the administrator assesses this response, which can either consist of re-assessing the analysis rule in the case of static rules (FIG. 10) or of supplying information that is useful for the intelligent learning process in the case of dynamic re-assessment (FIG. 11).

The method according to the present invention secures and enhances the performance of the system with the help of five processes that handle the alerts issued by the peripheral modules.

As regards active securitisation of the system, a first process of assessment and correlation of alerts compares the events issued by the low-level analysis system in order to determine whether or not an alert should be emitted. The deductions that emerge from comparing events with signatures are generalised in order to detect variants of the already-identified causes of alerts. This is called case-based reasoning. The assessment can be carried out independently on the client workstation where the signatures downloaded with the software are stored (updates possibly available on the server), or at a second level on the server in order to correlate the events issued by several clients. The server correlates information such as the number of workstations having the same attack, the type of attack, the time elapsed between several attacks and deduces from this information, with regard to the signatures/profiles it has available in a database, called “history” database, whether or not it is a distributed attack on several clients.

The use of a correlation engine enables improved attack detection. This engine is physically present on the network client workstation and on the server. At client level, the analysis consists of correlating the actions relating to identical predicates in a given time sequence, in order to detect a possible attack scenario. At server level, the correlation is extended in order to compare information coming from various points of the network, in order to increase the speed of detection of worm or denial-of-service attacks.

At the core of the active security system, the action planning process collects the alerts issued by the preceding process, addresses them to the weighting system in order better to qualify them, and then compares them with the rules of the security policy in order to activate the proper measures for the countermeasure execution process. This process also notifies the network administrators of the alerts issued and the actions undertaken.

The alerts emitted by the assessment and correlation system are not always relevant to the particularities of a given company. A step of weighting, on the server, thus makes it possible to respond to these alerts according to the network management practices and constraints and the security of the company. With this aim, an expert system can process this information according to the history of the administrator's reactions to the alert or to the family of alerts to which it belongs, and to the frequency with which they appear. The information is always sent to the server, even if the client workstation was capable of processing the event detection. In the opposite case, the server makes arrangements regarding the client workstation by means of this step.

This is followed by the execution of measures taken by the system core (the processing of countermeasures) consisting of implementing countermeasures by communicating with the relevant third-party systems (company firewall, client firewall, access points, router, etc.). These actions or measures can be applied to third-party equipment by way of prevention. The process also makes sure to verify and store the results of the actions performed.

Finally, the administrator and/or the user of the client workstation are notified of an alert when the connection with the network is temporarily broken. On his supervision/management consoles, the administrator is then asked to qualify the alert in order to increase the quality of the data (learning) and improve the relevance of the way the system reacts in future to similar events, by means of the process of weighting. Qualification is a manual operation by means of which the administrator provides his feedback regarding an event that took place on the network and triggered an automatic response in the system described above. For many reasons, the administrator can choose to neglect the automatic prevention and detection of a given alert or of the family to which it belongs: use of other tools, authorisation of certain applications that cause the event, specific configuration of the network, etc.

As regards the active enhancement of system performance, the processes involved are almost identical although they are adapted to the quality of service instead of being aimed at attack management.

Thus, the assessment system deals with the management of events relating to quality of service: availability of access points, frequency saturation, network status, etc.

The processes of action planning, weighting and notification/qualification are identical to the active security processes.

Dynamic reconfiguration of network equipment is ensured by executing measures taken by the core of the system, measures that aim to improve and enhance the operation of the network, starting with the access points.

The present invention implements complex intrusion scenarios based on knowledge of artificial intelligence, which sets it apart from the state of the art, with considerable use of static attack signature databases. The chosen solution therefore makes it possible to detect attack variants that have never been tracked and to restore the context that makes it possible to judge whether a suspicious event is actually malicious or innocent. In addition, it incorporates a retroaction device (learning system) allowing the network administrator gradually to adapt the automatic responses of the system to the particularities of the company's security and administration policies.

In reference to FIG. 12, the “scenario selector” and “supervised learning” boxes represent the key processes that implement the required artificial intelligence techniques. An attack can be detected on the basis of known scenarios (and signatures contained in the database) and an action can then be undertaken (box 1). When an event cannot be resolved (box2), the event is sent to the server and the latter makes a decision and acts (box 4). The administrator qualifies these decisions and actions (box 3), which will be learnt and integrated by the system by means of the intelligent “supervised learning” process.

In a specific embodiment of the invention, the method also has additional functions: the software itself is protected against possible attacks. As described above, the intelligent active kernel can comprise a “low-level” part and a “userland” part: the modules. This second part is protected yet easily accessible. The “low-level” active kernel grants it the necessary protection against attacks and thereby prevents deactivation, corruption, configuration modifications.

In another embodiment of the present invention, it is notable that a client workstation is not necessarily connected to a computer network and, in particular, is not necessarily connected permanently to a server.

In addition, the client can connect at specific instants (and not continuously) to the server that contains the data (new rules). For example, it is possible to imagine a scenario in which the user goes to his office once a week and connects to receive updates.

In the case of home use, the present invention provides active protection at both the system and client workstation levels. Since the workstation is not connected to a corporate network, there is no server. The steps of correlation and weighting by the server are not therefore performed, but the system profile and the static rules can still be implemented locally (on the client workstation).

The invention is described in the preceding paragraphs as an example. It is understood that those skilled in the trade will be capable of producing different variants of the invention without thereby departing from the context of the patent.

1. Method of securing computer equipment that are client workstations connected to each other by means of a computer network or a communication network and forming at least one information system, said system comprising at least one computer server, characterised in that the method comprises two steps of correlating digital data relating to security of the network and of the system or systems, the first step being implemented in the client workstation(s), combining system data and data obtained from the network by scanning entire layers, known as OSI model, from a transport layer to an application layer; the second step being executed in the server by combining “history” data obtained from digital databases, other “history” data stored in memory, and correlation data obtained from said first step,
and in that the method also comprises, following each of said two correlation steps, a step of comparing said correlation data with security policy rules and a step of activating countermeasures according to a result of the comparison.

2. Method of securing computer equipment according to claim 1, characterised in that it also comprises a step of correlation with user events at the client workstation level, such events being considered as executables

3. Method of securing computer equipment according to claim 1, characterised in that it implements XML (eXtended Markup Language) technology.

4. Method of managing computer attacks implementing the security method according to claim 1, characterised in that one of said countermeasures consists of sending at least one blocking command.

5. Method of managing computer attacks according to claim 4, characterised in that the blocking command is sent to a router.

6. Method of managing computer attacks according to claim 4, characterised in that the blocking command is sent to a terminal or an access point.

7. Method of managing computer attacks according to claim 4, characterised in that the blocking command is sent to a firewall.

8. Method of managing computer attacks according to claim 4, characterised in that the blocking command is sent to one or more of said client workstations.

9. Method of managing computer attacks according to claim 4, characterised in that the blocking command is sent to one or more computer applications

10. Method of managing computer attacks according to claim 4, characterised in that the (at least one) blocking command is limited in the time domain by means of a network management console.

11. Method of managing computer attacks according to claim 4, characterised in that the (at least one) blocking command is sent when an event that fulfils a specific criterion occurs, said specific criterion being a port, an application, services, frames or packets.

12. Method of managing an attack according to claim 1, characterised in that at least a part of said system data from said first step is defined following a step of learning about the behaviour of the system.

13. Method of managing an attack according to claim 1, characterised in that it comprises, in addition, a step of an administrator qualifying the decisions made by the system, and characterised in that at least part of said “history” data from said second step is defined following a step of learning step about said administrator qualifications.

14. System for securing digital communication networks, comprising:
at least one computer server;
at least one digital database;
at least one network management console implemented on a client workstation;
at least one user workstation on which a specific application is installed, in particular one which has “probe” type functions;
said (at least one) server being connected to said (at least one) digital database, and to said (at least one) network management console by a first cabled communication network (fixed) comprising a private part and a DMZ-type semi-public part (. . . );
said first network being connected to a wireless network or to a plurality of networks by means of equipment;
said user workstation being connected to said network;
characterised in that
said specific application emits, periodically and/or according to the performance of a specific event, digital data relating to the client workstation comprising indicators relating to at least one of the following parameters:
i. attacks/security;
ii. network reception quality;
iii. malfunctions of the specific application;
the server comprises means for correlating, on the one hand, said digital data relating to the client workstation and the data obtained from said database and/or data relating to one or more other client workstation(s), these means supplying correlation indices as their output; means for identifying and categorising possible attacks on the network; means for assessing and grading the relevance of possible risks relating to the data received based on a plurality of criteria.

15. System for securing networks according to claim 14, characterised in that said network is a wireless network.

16. System for securing networks according to claim 14, characterised in that said network is a Personal Area Network (PAN).

17. System for securing networks according to claim 15, characterised in that said wireless network is a Wireless Local Area Network (WLAN).

18. System for securing networks according to claim 15, characterised in that said wireless network is a Wireless Metropolitan Area Network (W-MAN).

19. System for securing networks according to claim 15, characterised in that said wireless network is a digital mobile telecommunications network.

20. System for securing networks according to claim 14, characterised in that said digital database is a relational DBMS (DataBase Management System).

21. System for securing networks according to claim 14, characterised in that said network management console is capable of managing different types of equipment.
